(19) United States
(12) Patent Application Publication
(10) Pub. No.: US 2025/0231888 A1
(43) Pub. Date: Jul. 17, 2025

(54) METHOD AND APPARATUS FOR MEMORY MANAGEMENT IN TARGET OPERATING SYSTEM

(71) Applicant: Alipay (Hangzhou) Information Technology Co., Ltd., Hangzhou (CN)

(72) Inventors: Yuke PENG, Hangzhou (CN); Hongliang TIAN, Hangzhou (CN); Shoumeng YAN, Hangzhou (CN); Yinqian ZHANG, Hangzhou (CN)

(21) Appl. No.: 19/017,145

(22) Filed: Jan. 10, 2025

(30) Foreign Application Priority Data
Jan. 16, 2024 (CN) 202410065867.9

(51) Int. Cl. G06F 12/14

(52) U.S. Cl. CPC G06F 12/1441; G06F 12/1483

(57) ABSTRACT

Embodiments of this specification provide a method and an apparatus for memory management in a target operating system. The target operating system is written in a Rust language. The Rust language includes an unsafe keyword. The method is performed by a memory management module. The memory management module includes a management interface module and a kernel code module. The method includes: receiving, by the management interface module, a memory request sent by program code, where neither the program code nor the management interface module includes a code segment using the unsafe keyword; and when target security assurance is ensured based on the management interface module, performing, by the kernel code module, a memory operation corresponding to the memory request by using code that includes the unsafe keyword, where the target security assurance is related to the memory operation.

### TECHNICAL FIELD

One or more embodiments of this specification relate to a computer operating system, and in particular, to a method and an apparatus for memory management in an operating system.

### BACKGROUND

A Rust language is an emerging system programming language that can eliminate much of problematic code during compilation through a security check. In addition, there is no characteristics such as runtime and a garbage collection mechanism. Therefore, the Rust code runs much faster than languages such as Java and Python, and can be qualified for high-performance scenarios. These advantages make the Rust language increasingly popular.

A Rust compiler performs a mandatory check, so that no undefined behavior such as null pointer access is caused when a program runs, thereby eliminating much of problematic code during compilation. However, in Rust, there is a special keyword named unsafe, and the keyword can mark a code block, so that the compiler does not perform some mandatory checks on the code block, but a programmer needs to be responsible for security of the code block. The keyword appears because there is no flexibility in some scenarios when code checked only by the compiler is used and consequently the program cannot perform special operations. To enable the program to have higher performance or implement special functions, the Rust compiler provides the unsafe keyword to grant higher permission to the program.

The unsafe keyword is mainly used in two scenarios: In a first scenario, the unsafe keyword marks a function, indicating that when using the function, the programmer needs to meet some conditions defined by the function, to ensure that the program does not generate undefined behavior. This is referred to as unsafe-marked code. In a second scenario, the unsafe keyword marks a process, including using a function or performing an unsafe operation defined by the compiler, for example, modifying a mutable static variable and dereferencing a raw pointer. This is referred to as unsafe-used code. In a scenario of the unsafe-used code, the programmer needs to ensure use security based on a condition that the function or the unsafe operation needs to meet.

The Rust language gradually demonstrates its advantages in the operating system field during development, attracting more people to use Rust to write operating systems. However, in an operating system written in Rust, use of the unsafe keyword is always a relatively significant problem. Incorrect use of the unsafe keyword is very prone to cause system instability or even crashes. Excessive use of the unsafe keyword causes a great trust burden and risk.

It is hoped that there can be an improved solution to alleviate the security and trust problems related to the unsafe keyword in the operating system written in Rust.

### SUMMARY

One or more embodiments of this specification describe a method and an apparatus for memory management in an operating system written in Rust, to reduce a trusted base of the operating system in terms of memory management, so as to improve system stability and security.

According to a first aspect, a method for memory management in a target operating system is provided. The target operating system is written in a Rust language. The Rust language includes an unsafe keyword. The method is performed by a memory management module. The memory management module includes a management interface module and a kernel code module. The method includes:
receiving, by the management interface module, a memory request sent by program code, where neither the program code nor the management interface module includes a code segment using the unsafe keyword; and
upon determining that target security assurance is ensured based on the management interface module, performing, by the kernel code module, a memory operation corresponding to the memory request by using code that includes the unsafe keyword, where the target security assurance is related to the memory operation.

According to an implementation, the memory request can be a first request for creating an access object and allocating a memory to the access object, the management interface module includes a memory page allocator, and correspondingly, the method further includes: allocating, by the memory page allocator, a first physical address based on a memory allocation algorithm.

Further, in an example of the above-mentioned implementation, the memory page allocator confirms that the first physical address is not within a typed memory segment; and the first physical address is not occupied by another owner, to ensure the target security assurance.

In an embodiment, performing, by the kernel code module, a memory operation corresponding to the memory request by using code that includes the unsafe keyword specifically includes: creating an access object, and importing the first physical address as a memory address of the access object by using a target function involving the unsafe keyword.

According to another implementation, the memory request includes a second request for accessing a target memory page, and the management interface module includes a memory access interface.

In an embodiment in this case, the memory access interface performs a bounds check to ensure that an access address does not exceed a bound of the target memory page, to ensure the target security assurance.

In an embodiment, performing, by the kernel code module, a memory operation corresponding to the memory request by using code that includes the unsafe keyword specifically includes: accessing a physical address corresponding to the target memory page by using a raw pointer dereferencing operation identified by the unsafe keyword.

According to still another implementation, the memory request includes a kernel page table operation request, the management interface module includes a page table operation interface, and the method further includes: obtaining, by the page table operation interface, a kernel page table instance, to perform a kernel page table operation.

In an embodiment in this case, the page table operation interface ensures that the kernel page table operation request is a read operation request; or upon determining that the kernel page table operation request is a modification operation request, the page table operation interface verifies or requires that an operator has corresponding permission, to ensure the target security assurance.

Still further, in an example, the modification operation request is used to request to add a kernel stack guard page, and that an operator has corresponding permission includes obtaining ownership of the guard page before the kernel stack guard page is added.

According to an implementation, the memory management module further includes a global manager, the global manager implements a target trait in a Rust library and ensures a security requirement of the target trait, and the target trait is GlobalAlloc.

In an embodiment, the memory management module as a whole belongs to a trusted base of the target operating system.

According to a second aspect, a memory management module for memory management in a target operating system is provided. The target operating system is written in a Rust language. The Rust language includes an unsafe keyword. The memory management module includes a management interface module and a kernel code module.

The management interface module is configured to receive a memory request sent by program code, where neither the program code nor the management interface module includes a code segment using the unsafe keyword.

The kernel code module is configured to: upon determining that target security assurance is ensured based on the management interface module, perform a memory operation corresponding to the memory request by using code that includes the unsafe keyword, where the target security assurance is related to the memory operation.

According to a third aspect, a computer-readable storage medium is provided. The computer-readable storage medium stores a computer program, and when the computer program is executed in a computer, the computer is enabled to perform the method according to the first aspect.

According to a fourth aspect, a computing device is provided, and includes a storage and a processor. The storage stores executable code, and when the processor executes the executable code, the method according to the first aspect is implemented.

In the memory management architecture provided in the embodiments of this specification, there is a clear boundary between privileged code and non-privileged code. The privileged code includes the kernel code module that directly includes the unsafe code and the management interface module that does not include the unsafe code module but provides a security protection mechanism to the privileged code. In addition, the management interface module further functions as an interface, and interacts with the non-privilege level. In this way, the privilege level includes only the unsafe code and related security protection mechanism code, and needs to be reviewed before being put into use. This restricts a programmer from arbitrarily using the unsafe keyword, and minimizes a trusted base of the operating system, thereby improving system stability and security.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments of this specification, and a person of ordinary skill in the art can still derive other drawings from these accompanying drawings without creative efforts.

FIG. 1 is a schematic diagram of a memory management architecture according to an embodiment;

FIG. 2 is a flowchart of a method for memory management according to an embodiment;

FIG. 3 is a schematic diagram of memory request processing according to an embodiment; and

FIG. 4 is a schematic structural diagram of a memory management module according to an embodiment.

### DESCRIPTION OF EMBODIMENTS

The following describes, with reference to the accompanying drawings, the solutions provided in this specification.

In the following, an operating system written in a Rust language is briefly referred to as a Rust operating system. As described above, Rust provides an unsafe keyword, and mandatory checks by a Rust compiler can be avoided for a code segment identified by the keyword. Therefore, a trusted base of the Rust operating system closely depends on use of the unsafe keyword.

A trusted base is a set of all security protection mechanisms for implementing security protection of a computer system. The trusted base of the Rust operating system includes all modules using the unsafe keyword, including unsafe-used code and unsafe-marked code. For a module that includes the unsafe-used code, a security condition required by the unsafe-marked code needs to be met, so that no security problem occurs in the system. This is a protection mechanism made for protecting system security, and therefore is incorporated into the trusted base. A module that includes the unsafe-marked code causes the system to generate more unsafe-used code modules. If the unsafe-used code module is incorporated into the trusted base, the unsafe-marked code needs to be synchronously incorporated. As the Rust operating system becomes increasingly large, if the unsafe-used code is not reduced and managed, the trusted base of the Rust operating system becomes increasingly large, which adversely affects security, stability, and maintainability of the operating system.

In some existing Rust operating systems such as Thesus, RedLeaf, and Tock, some efforts are made in managing the unsafe keyword. However, permission of a programmer to use the unsafe still cannot be effectively restricted, arbitrary writing of the unsafe keyword is not fundamentally prevented, and a code amount of the unsafe keyword and a security protection mechanism thereof cannot be effectively reduced. Consequently, the system still has a relatively great security and stability risk.

Memory management is a basic and important task in the operating system. In the Rust operating system, the unsafe keyword usually needs to be used to provide and manage memory-related kernel resources. Therefore, in terms of memory management, how to more effectively manage and restrict use of the unsafe keyword and reduce the system trusted base is of great significance for improving system security and stability.

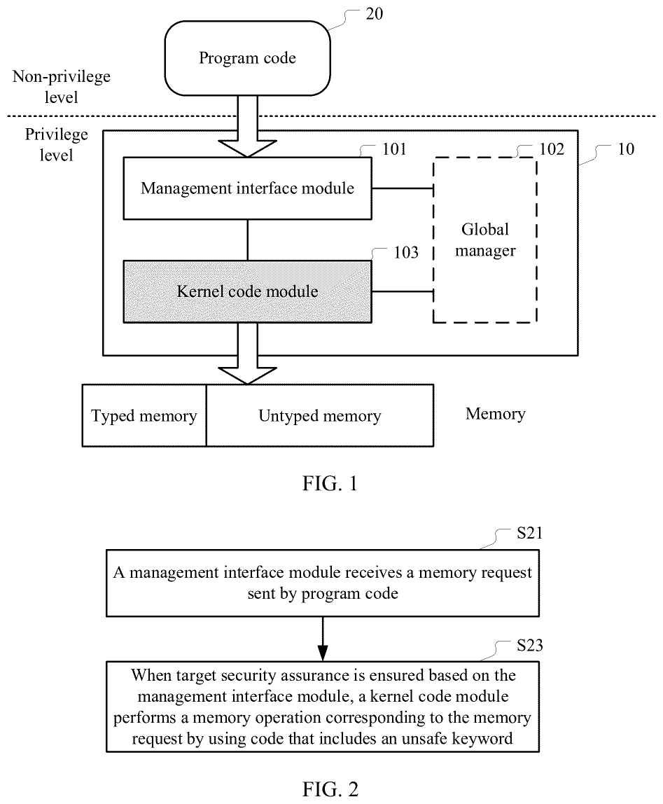

Therefore, in the embodiments of this specification, a memory management method and architecture are provided. FIG. 1 is a schematic diagram of a memory management architecture according to an embodiment. Based on this architecture, to restrict, from the source, a programmer from arbitrarily writing code that includes unsafe and minimize a trusted base as much as possible, in the memory management architecture of this solution, privileged code and non-privileged code in memory-related code are separated, with a boundary defined between them. A privilege level includes only unsafe code and additional security protection mechanism code generated to achieve system security. Code logic at the privilege level needs to be strictly reviewed before being put into use. A non-privilege level has no permission to use the unsafe code.

Specifically, in the memory management architecture in FIG. 1, a memory management module 10 that performs memory management is privileged code, and program code 20 that uses a memory is non-privileged code. The program code 20 is usually system program code.

The memory management module 10 can further include a management interface module 101, a global manager 102, and a kernel code module 103. The kernel code module 103 is shown in a gray background, indicating that the kernel code module 103 includes code identified by an unsafe keyword. The kernel code module 103 can directly operate a memory by using the unsafe code. The memory can be divided into a typed memory segment and an untyped memory segment. The typed memory stores important data such as kernel code, while the untyped memory does not store important data after initialization at the privilege level and can be allocated and accessed.

The management interface module 101 and the global manager 102 do not include the unsafe code, but provide assurance for correct and secure execution of the kernel code module 103 that includes the unsafe code, and are protection mechanism code made to protect system security, and therefore also belong to the privilege level. Specifically, the global manager 102 provides data structure support and assurance for dynamic memory allocation by implementing a GlobalAlloc trait in a Rust library. The management interface module 101 serves as an interface provided to the program code 20, and further provides security assurance for execution of the kernel code module 103.

The following describes in detail an implementation of and a memory management process performed by each module in the memory management module.

An implementation and a role of the global manager are first described.

It is known to a person skilled in the art that in Rust, a trait is a language characteristic that defines some method sets, and is similar to an interface in another language. GlobalAlloc is a trait in the Rust official library, and defines a series of methods for dynamic memory allocation, for example, alloc (for memory allocation) and dealloc (for memory release). In addition, when dynamic memory allocation is performed in Rust, specific data structures need to be used for various data types (for example, Box, Vec, and String). A Rust alloc library provides these necessary data structures. The use of the Rust alloc library depends on the implementation of the GlobalAlloc trait.

Therefore, the global manager needs to be provided in the memory management module. The global manager needs to implement the GlobalAlloc trait, to define a memory allocation method and use a data structure provided by the Rust alloc library. The global manager can also be referred to as a Rust alloc module.

Specifically, to customize the global manager, a structure can be created, and the GlobalAlloc trait is implemented for the structure. Therefore, an instance of this structure can be set to the global manager.

The GlobalAlloc trait is an unsafe trait in Rust. Therefore, when the GlobalAlloc trait is implemented by using code to obtain the global manager, a writer needs to ensure security assurance in at least two aspects. A first aspect is that an implemented function needs to ensure that no panic can be generated. When a Rust program encounters an unrecoverable error, a panic is generated. A reason why the panic is generated may be an array out of bounds, an illegal call, or various other reasons. A second aspect is to ensure correctness of an allocation algorithm. The allocation algorithm is defined in the GlobalAlloc trait. Subsequently, in the face of a memory allocation request, the management interface module performs memory allocation by using the allocation algorithm. The writer needs to ensure, in terms of code logic, that the global manager meets the security assurance in the above-mentioned two aspects.

On the basis of implementing the above-mentioned global manager and providing data structure and allocation algorithm support for memory management, memory request processing and security assurance can be performed through the management interface module 101.

FIG. 2 is a flowchart of a method for memory management according to an embodiment. As shown in FIG. 2, the method includes the following steps.

In step S21, a management interface module receives a memory request sent by program code. As described above, the program code is non-privileged code, and does not include a code segment using an unsafe keyword. In practice, the program code is usually system program code. When a user-mode program needs to use a memory in a running process, a request is usually sent to an operating system, to perform conversion into sending of a request by the system program code to a memory management module.

In step S23, when target security assurance is ensured based on the management interface module, a kernel code module performs a memory operation corresponding to the memory request by using code that includes the unsafe keyword, where the target security assurance is related to the memory operation.

In different embodiments, the memory request can be a memory allocation request, a memory access request, and a memory page table operation request. The following describes target security assurance and a memory operation manner that are to be implemented in each of these cases.

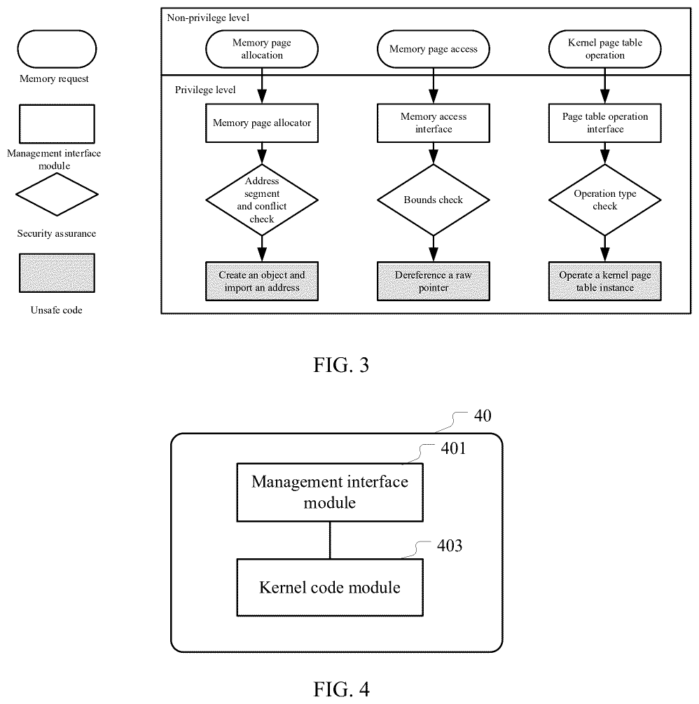

FIG. 3 is a schematic diagram of memory request processing according to an embodiment. In FIG. 3, three processing procedures that are parallel in a vertical direction correspond to different memory requests.

In a first case, the memory request is a request for creating an access object and allocating a memory to the access object. Correspondingly, the management interface module 101 in FIG. 1 includes a memory page allocator, configured to process such requests. Specifically, the memory page allocator allocates a specific physical address, which is referred to as a first physical address below, based on a memory allocation algorithm. The memory allocation algorithm herein is an algorithm defined when the above-mentioned global manager is implemented, and correctness of the algorithm is ensured by a writer of the global manager.

In addition, the memory page allocator further needs to perform security assurance related to memory allocation. Specifically, the memory page allocator needs to confirm that the first physical address is not within a typed memory segment and does not affect security of kernel code data. In addition, the memory page allocator further needs to confirm that the first physical address is not occupied by another owner and does not cause an address conflict.

When the memory page allocator ensures the security assurance related to memory allocation, the kernel code module performs the corresponding memory operation. Specifically, the kernel code module creates an access object, and imports the first physical address as a memory address of the access object by using a target function involving the unsafe keyword. The access object can be a variable, a function, an instance, etc. It can be understood that because the memory page allocator verifies validity and security of the first physical address, execution security of the unsafe code segment for importing the first physical address can be ensured.

In a second case, the memory request is an access request for accessing a target memory page. Correspondingly, the management interface module 101 in FIG. 1 includes a memory access interface, configured to process such requests. Specifically, the memory access interface serves as an interface for interacting with the non-privilege level, receives the access request for the target memory page, and ensures security assurance related to the access request. Therefore, the memory access interface performs a bounds check to ensure that an access address does not exceed a bound of the target memory page.

On this basis, the kernel code module executes memory page access by using a raw pointer operation that includes the unsafe keyword.

Specifically, in Rust, a raw pointer provides a low-level method for processing a memory. Unlike a regular pointer reference in Rust, the raw pointer neither ensures that a memory to which the raw pointer points is valid nor ensures compliance with a borrowing rule in Rust. Therefore, an operation on the raw pointer is located in a code block identified by unsafe, and a programmer is independently responsible for memory security. In Rust, an operation of reading stored data from any physical address involves raw pointer dereferencing. Therefore, specifically, the kernel code module accesses a physical address corresponding to the target memory page by using a raw pointer dereferencing operation identified by the unsafe keyword. Because the memory access interface verifies a bound of the access address, it can be ensured that the physical address accessed by the kernel code module does not exceed a legal bound, to ensure secure execution of the unsafe code segment.

In a third case, the memory request is a kernel page table operation request. Correspondingly, the management interface module 101 in FIG. 1 includes a page table operation interface, configured to process such requests.

A kernel page table is a data structure used by an operating system kernel to manage memory virtualization, and records a mapping of a virtual address to a physical address of kernel space. Usually, when the system is started, a kernel page table instance is created to provide an initial virtual-to-physical mapping for the kernel space. The initial kernel page table instance is usually placed in a fixed area of a system memory, and is not moved or released in an entire life cycle of the system. After the system runs, all operations on the kernel virtual address space, for example, memory mapping and demapping, need to be completed by modifying the kernel page table instance.

In an embodiment, when receiving the kernel page table operation request, the page table operation interface obtains the kernel page table instance from the fixed area of the memory, to perform a kernel page table operation by using the kernel page table instance.

In addition, the page table operation interface can further perform basic security confirmation for the kernel page table operation request. Specifically, in an example, the page table operation interface determines a request type of the kernel page table operation request. If the kernel page table operation request is a read request for a kernel page table, for example, a request for reading a mapping relationship of some addresses to perform translation from a virtual address to a physical address, the request is directly released, and the kernel code module performs a corresponding operation. If the kernel page table operation request is a modification request related to a kernel page table, permission of an operator is verified. When the operator is allowed to perform modification, code of the operator should also be incorporated into a trusted base.

In an example, the operator ensures security of the modification request related to the kernel page table, and the page table operation interface can send a reminder or a requirement. Specifically, the modification request can include modifying a mapping of the kernel page table, for example, adding an entry related to a kernel stack guard page. The kernel stack guard page is a security mechanism and is used to prevent kernel stack overflow attacks and other potential stack-related security vulnerabilities. In most operating systems, each kernel thread usually has a dedicated kernel stack used to store return addresses for function calls and local variables and store contexts when system calls and interrupt service routines are executed. A working mechanism of the kernel stack guard page is that a memory page, referred to as a “guard page”, is reserved at the bottom of a kernel stack (or at the top, depending on a direction of the stack), and is set to inaccessible. If a stack of a kernel thread accesses the guard page out of bounds due to overflow or other reasons, a processor generates a page error due to a violation of memory protection. Therefore, the kernel stack guard page can be used to sense stack overflow. When the operation request for the kernel page table is to add the kernel stack guard page, it is preferred that the operator ensures security of the request. Specifically, it is ensured that ownership of the page is obtained before the kernel stack guard page is added, and the page is re-mapped when a thread to which the kernel stack belongs is destroyed.

In another example, the page table operation interface may further receive a modification request for a user-mode page table. In this case, the page table operation interface performs a bounds check on the modification request, to prevent incorrect access to the kernel-mode page table during modification of the user-mode page table, so as to further ensure security of the kernel-mode page table.

On the basis of ensuring the security assurance related to the kernel page table operation, the kernel code module performs a corresponding operation on the kernel page table instance. All operations on the kernel page table instance are underlying memory operations, and use a code segment identified by unsafe. Execution security of the unsafe code segment is provided by the above-mentioned security assurance.

With reference to the above-mentioned several cases, it can be seen that in the memory management architecture of this solution, there is a clear boundary between privileged code and non-privileged code. The privileged code includes the kernel code module that directly includes the unsafe code and the management interface module that does not include the unsafe code module but provides a security protection mechanism to the privileged code. In addition, the management interface module further functions as an interface, and interacts with the non-privilege level. In this way, the privilege level includes only the unsafe code and related security protection mechanism code, and needs to be reviewed before being put into use. This restricts a programmer from arbitrarily using the unsafe keyword (unsafe cannot be used in a program at the non-privilege level), and minimizes a trusted base of the operating system, thereby improving system stability and security.

In addition, corresponding to the above-mentioned method process, an embodiment of this specification further provides a memory management module for memory management in a target operating system. The target operating system is written in a Rust language. The Rust language includes an unsafe keyword. FIG. 4 is a schematic structural diagram of a memory management module according to an embodiment. As shown in the figure, the memory management module 40 includes a management interface module 401 and a kernel code module 403.

The management interface module 401 is configured to receive a memory request sent by program code, where neither the program code nor the management interface module includes a code segment using the unsafe keyword.

The kernel code module 403 is configured to: when target security assurance is ensured based on the management interface module, perform a memory operation corresponding to the memory request by using code that includes the unsafe keyword, where the target security assurance is related to the memory operation.

For a specific execution process example of the memory management process, refer to the above-mentioned descriptions provided with reference to FIG. 2 and FIG. 3. Details are not described again.

According to an embodiment in still another aspect, a computing device is further provided, including a storage and a processor. The storage stores executable code, and when the processor executes the executable code, the method described with reference to FIG. 2 and FIG. 3 is implemented.

A person skilled in the art should be aware that in the above-mentioned one or more examples, functions described in this specification can be implemented by hardware, software, firmware, or any combination thereof. When being implemented by software, these functions can be stored in a computer-readable medium or transmitted as one or more instructions or code on a computer-readable medium.

In the above-mentioned specific implementations, the objectives, technical solutions, and beneficial effects of this specification are further described in detail. It should be understood that the above-mentioned descriptions are merely specific implementations of this specification, but are not intended to limit the protection scope of this specification. Any modification, equivalent replacement, improvement, etc. made based on the technical solutions of this specification shall fall within the protection scope of this specification.

1. A method for memory management in a target operating system, wherein the target operating system is written in a Rust language, the Rust language comprises an unsafe keyword, the method is performed by a memory management module, the memory management module comprises a management interface module and a kernel code module, and the method comprises:
receiving, by the management interface module, a memory request sent by program code, wherein neither the program code nor the management interface module comprises a code segment using the unsafe keyword; and
upon determining that target security assurance is ensured based on the management interface module, performing, by the kernel code module, a memory operation corresponding to the memory request by using code that comprises the unsafe keyword, wherein the target security assurance is related to the memory operation.

2. The method according to claim 1, wherein the memory request comprises a first request for creating an access object and allocating a memory to the access object, the management interface module comprises a memory page allocator, and the method further comprises:
allocating, by the memory page allocator, a first physical address based on a memory allocation algorithm.

3. The method according to claim 2, wherein ensuring target security assurance based on the management interface module specifically comprises: confirming the following based on the memory page allocator:
the first physical address is not within a typed memory segment; and
the first physical address is not occupied by another owner.

4. The method according to claim 2, wherein performing a memory operation corresponding to the memory request by using code that comprises the unsafe keyword comprises:
creating an access object, and importing the first physical address as a memory address of the access object by using a target function involving the unsafe keyword.

5. The method according to claim 1, wherein the memory request comprises a second request for accessing a target memory page, and the management interface module comprises a memory access interface.

6. The method according to claim 5, wherein ensuring target security assurance based on the management interface module specifically comprises: performing a bounds check based on the memory access interface to ensure that an access address does not exceed a bound of the target memory page.

7. The method according to claim 5, wherein performing a memory operation corresponding to the memory request by using code that comprises the unsafe keyword comprises:
accessing a physical address corresponding to the target memory page by using a raw pointer dereferencing operation identified by the unsafe keyword.

8. The method according to claim 1, wherein the memory request comprises a kernel page table operation request, the management interface module comprises a page table operation interface, and the method further comprises:
obtaining, by the page table operation interface, a kernel page table instance, to perform a kernel page table operation.

9. The method according to claim 8, wherein ensuring target security assurance based on the management interface module comprises:
ensuring, by the page table operation interface, that the kernel page table operation request is a read operation request; or
upon determining that the kernel page table operation request is a modification operation request, verifying or requiring, by the page table operation interface, that an operator has corresponding permission.

10. The method according to claim 9, wherein the modification operation request is used to request to add a kernel stack guard page, and that an operator has corresponding permission comprises obtaining ownership of the guard page before the kernel stack guard page is added.

11. The method according to claim 1, wherein the memory management module further comprises a global manager, the global manager implements a target trait in a Rust library and ensures a security requirement of the target trait, and the target trait is GlobalAlloc.

12. The method according to claim 1, wherein the memory management module as a whole belongs to a trusted base of the target operating system.

13. (canceled)

14. A computing device, comprising a storage and a processor, wherein the storage stores executable instructions that, in response to execution by the processor, causes the computing device to implement a method for memory management in a target operating system, wherein the target operating system is written in a Rust language, the Rust language comprises an unsafe keyword, the method is performed by a memory management module, the memory management module comprises a management interface module and a kernel code module, and the method comprises:
receiving, by the management interface module, a memory request sent by program code, wherein neither the program code nor the management interface module comprises a code segment using the unsafe keyword; and
upon determining that target security assurance is ensured based on the management interface module, performing, by the kernel code module, a memory operation corresponding to the memory request by using code that comprises the unsafe keyword, wherein the target security assurance is related to the memory operation.

15. The computing device according to claim 14, wherein the memory request comprises a first request for creating an access object and allocating a memory to the access object, the management interface module comprises a memory page allocator, and the method further comprises:
allocating, by the memory page allocator, a first physical address based on a memory allocation algorithm.

16. The computing device according to claim 15, wherein ensuring target security assurance based on the management interface module specifically comprises: confirming the following based on the memory page allocator:
the first physical address is not within a typed memory segment; and
the first physical address is not occupied by another owner.

17. The computing device according to claim 15, wherein performing a memory operation corresponding to the memory request by using code that comprises the unsafe keyword comprises:
creating an access object, and importing the first physical address as a memory address of the access object by using a target function involving the unsafe keyword.

18. The computing device according to claim 14, wherein the memory request comprises a second request for accessing a target memory page, and the management interface module comprises a memory access interface.

19. The computing device according to claim 18, wherein ensuring target security assurance based on the management interface module specifically comprises: performing a bounds check based on the memory access interface to ensure that an access address does not exceed a bound of the target memory page.

20. The computing device according to claim 18, wherein performing a memory operation corresponding to the memory request by using code that comprises the unsafe keyword comprises:
accessing a physical address corresponding to the target memory page by using a raw pointer dereferencing operation identified by the unsafe keyword.

21. A non-transitory computer-readable storage medium comprising instructions stored therein that, when executed by a processor of a computing device, causes the computing device to implement a method for memory management in a target operating system, wherein the target operating system is written in a Rust language, the Rust language comprises an unsafe keyword, the method is performed by a memory management module, the memory management module comprises a management interface module and a kernel code module, and the method comprises:
receiving, by the management interface module, a memory request sent by program code, wherein neither the program code nor the management interface module comprises a code segment using the unsafe keyword; and
upon determining that target security assurance is ensured based on the management interface module, performing, by the kernel code module, a memory operation corresponding to the memory request by using code that comprises the unsafe keyword, wherein the target security assurance is related to the memory operation.
